(19) United States
(12) Patent Application Publication
(10) Pub. No.: US 2014/0158805 A1
(43) Pub. Date: Jun. 12, 2014

(54) RETRACTOR PRETENSIONER OF SEAT BELT FOR VEHICLE

(71) Applicant: HYUNDAI MOTOR COMPANY, Seoul (KR)

(72) Inventors: Dae Woon Kim, Suwon (KR); Choong Sik Shin, Anyang (KR)

(73) Assignee: HYUNDAI MOTOR COMPANY, Seoul (KR)

(21) Appl. No.: 13/856,612

(22) Filed: Apr. 4, 2013

(30) Foreign Application Priority Data
Dec. 12, 2012 (KR) 10-2012-0144961

(51) Int. Cl. B60R 22/46

(52) U.S. Cl. CPC B60R 22/4628
USPC 242/374

(57) ABSTRACT

Disclosed herein is a retractor pretensioner of a vehicle seat belt. The retractor pretensioner of the present invention may prevent an overshoot phenomenon in which residual pressure of gas impedes reverse rotation of a spool when the pretensioner operates as a load limiter. The pretensioner includes a spool around which the seat belt is wound and wherein the spool is rotatably installed in a frame to rotate the spool relative to the frame by gas pressure transmitted from a gas generator to the spool. In addition, the pretensioner includes a valve shaft that is installed in the spool, wherein the valve shaft operates as a rotating shaft of the gas generator with respect to the frame when the gas generator is not operated and as a valve, through which the gas is discharged out of the spool, when the gas generator is operated.

### CROSS-REFERENCE TO RELATED APPLICATION

This application claims under 35 U.S.C. §119(a) the benefit of Korean Patent Application No. 10-2012-0144961 filed on Dec. 12, 2012 the entire contents of which are incorporated herein by reference.

### BACKGROUND OF THE INVENTION

1. Field of the Invention

The present invention relates generally to retractor pretensioners of vehicle seat belts and, more particularly, to a retractor pretensioner of a vehicle seat belt which can prevent an overshoot phenomenon from being caused when operated as a load limiter, and which has a reduced size, thus enhancing space efficiency.

2. Description of the Related Art

Conventional seat belt pretensioners are classified into a steel ball type pretensioner and a rack type pretensioner. As shown in FIG. 1, in the steel ball type pretensioner, when a gas generator 1 is operated, steel balls 3 are moved along a passageway 4 and discharged from an installation space by pressure of gas 2 generated by the operation of the gas generator 1. Furthermore, a ring gear 5 and a pinion 6 are rotated together (e.g., in a direction designated by arrow R1) by movement of the steel balls 3. When the pinion 6 rotates, a spool 7 which is connected to the pinion 6 is rotated. When the spool 7 rotates, the seat belt is wound around the spool 7, thus fixing the upper body of a passenger.

However, in the conventional steel ball type pretensioner, when operated as a load limiter, residual pressure of gas 2 present in the passageway 4 or friction of the steel balls 3 may impede reverse rotation (e.g., in a direction designated by arrow R2) of the ring gear 5 (this refers to an overshoot phenomenon). Thus, an initial load of the seat belt is increased, and the seat belt 2 may injure the passenger.

Moreover, in the conventional steel ball type pretensioner, the elements (e.g., the gas passage, the steel balls, the ring gear, etc.) which operate the spool 7 using pressure of the gas 2 are disposed outside the spool 7. As a result, the size of the pretensioner is increased, thus reducing space efficiency.

Additionally, as shown in FIG. 2, in the conventional rack type pretensioner, a rack 12 is moved along a guide 13 by gas pressure generated from the gas generator 11. When the pinion 14 rotates, the spool 15 rotates along with the pinion 14. When the spool 15 rotates, the seat belt 16 is wound around the spool 15, thus fixing the upper body of a passenger.

However, when the rack type pretensioner operates as a load limiter, residual pressure of gas may cause an overshoot phenomenon. In addition, the elements (e.g., the gas passage, the rack, etc.) which operate the spool 15 are disposed outside the spool 15, thus increasing the size of the pretensioner, thereby reducing space efficiency.

It is to be understood that the foregoing description is provided to merely aid the understanding of the present invention, and does not mean that the present invention falls under the purview of the related art which was already known to those skilled in the art.

### SUMMARY

Accordingly, the present invention provides a retractor pretensioner of a vehicle seat belt which may prevent an overshoot phenomenon from being caused when the retractor pretensioner operates as a load limiter, thus further enhancing passenger protection using the seat belt, and wherein the gas pressure may directly rotate the spool, thus simplifying the structure of the pretensioner and, particularly, reducing the size thereof, thereby enhancing space efficiency.

The present invention provides a retractor pretensioner of a vehicle seat belt, including: a spool around which the seat belt is wound, the spool being rotatably installed in a frame to rotate the spool relative to the frame by gas pressure transmitted from a gas generator to the spool; and a valve shaft installed in the spool, the valve shaft may be configured to operate as a rotating shaft of the gas generator with respect to the frame when the gas generator is not operated and as a valve, through which the gas may be discharged out of the spool, when the gas generator is operated. The gas generator may be installed in a first end of the spool to connect the gas generator is to the spool.

The spool may include: a gas passageway disposed in the spool; an installation part connected to the gas passageway and disposed on the first end of the spool, wherein the gas generator may be installed in the installation part; a gas discharge aperture through which the gas passageway communicates with an exterior of the spool; and an impeller disposed in the gas passageway, wherein the impeller may be configured to guide the gas, generated from the gas generator, towards the gas discharge aperture and rotating the spool with force generated by the gas flow.

The valve shaft may be configured to seal the gas discharge aperture of the spool, when the gas generator is not operated, and, when the gas generator is operated, the valve shaft may be moved from the spool by the gas pressure to open the gas discharge aperture.

The valve shaft may include: a valve plate configured to open and close the gas discharge aperture; an internal shaft protruding from a first surface of the valve plate, the internal shaft being disposed through the impeller; and a rotating shaft protruding from a second surface of the valve plate, the rotating shaft comprising an end rotatably disposed in a shaft aperture formed in the frame.

The valve shaft may further include a disc protruding from the second surface of the valve plate, wherein stopper protrusions having a serrated cross-section may be disposed on a surface of the disc to connect the stopper protrusions to each other with respect to a circumferential direction of the disc, the stopper protrusions, wherein when the valve plate may be moved toward the frame by the gas pressure, the stopper protrusions may be configured to abut the frame, thus preventing the valve shaft from rotating.

The internal shaft may have a conical shape in which a cross-sectional area thereof is gradually reduced from an end thereof that is connected to the valve plate to the other end adjacent to the gas generator. Furthermore, when the gas generator is not operated, no space may be formed between the internal shaft and the impeller.

A retractor pretensioner of a vehicle seat belt according to the present invention may prevent an overshoot phenomenon in which residual pressure of gas impedes reverse rotation of a spool when the pretensioner operates as a load limiter. Therefore, the present invention may further enhance the wear protection of the seat belt. Particularly, the elements which operate a spool using gas pressure may be integrally disposed within the spool, thus reducing the size of the pretensioner, thereby enhancing space efficiency. Furthermore, the number of parts of the pretensioner may be reduced, thus reducing the manufacturing cost and the weight of the pretensioner.

### BRIEF DESCRIPTION OF THE DRAWINGS

The above and other objects, features and advantages of the present invention will be more clearly understood from the following detailed description taken in conjunction with the accompanying drawings, in which:

FIGS. 1 and 2 are exemplary views illustrating a conventional steel ball type pretensioner and a conventional rack type pretensioner according to the related art;

FIGS. 3 through 5 are exemplary views showing the state of a retractor pretensioner of a vehicle seat belt to illustrate the state of the pretensioner when a gas generator is not operated, according to an exemplary embodiment of the present invention; and

FIGS. 6 and 7 are exemplary views showing the operation of the pretensioner when the gas generator is operated according to an exemplary embodiment of the present invention.

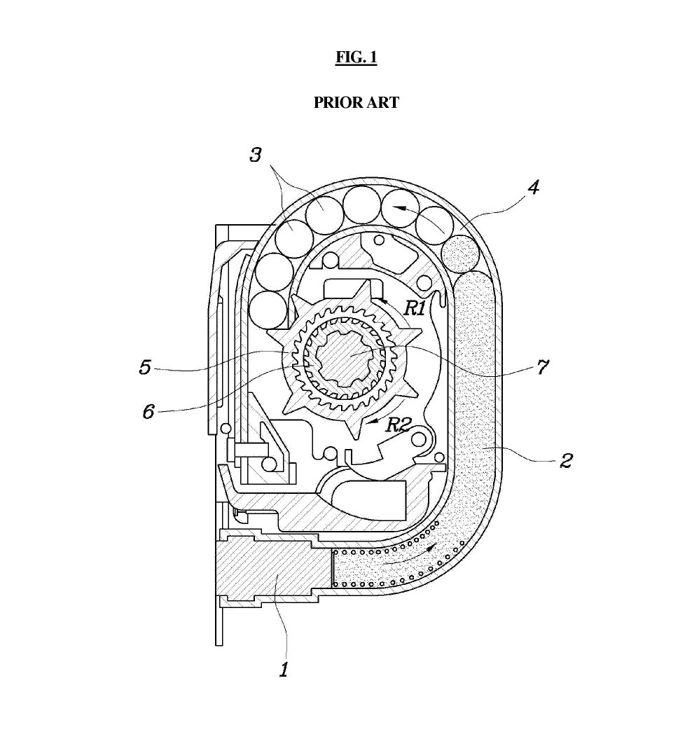

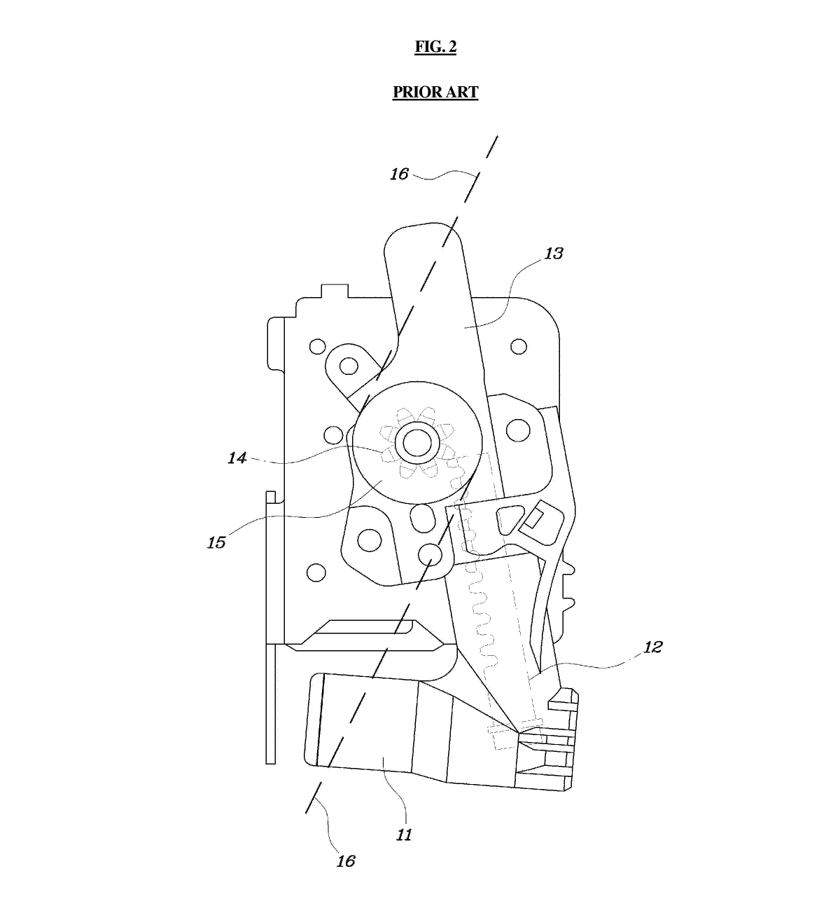

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Hereinafter, a retractor pretensioner of a vehicle seat belt according to an exemplary embodiment of the present invention will be described in detail with reference to the attached drawings.

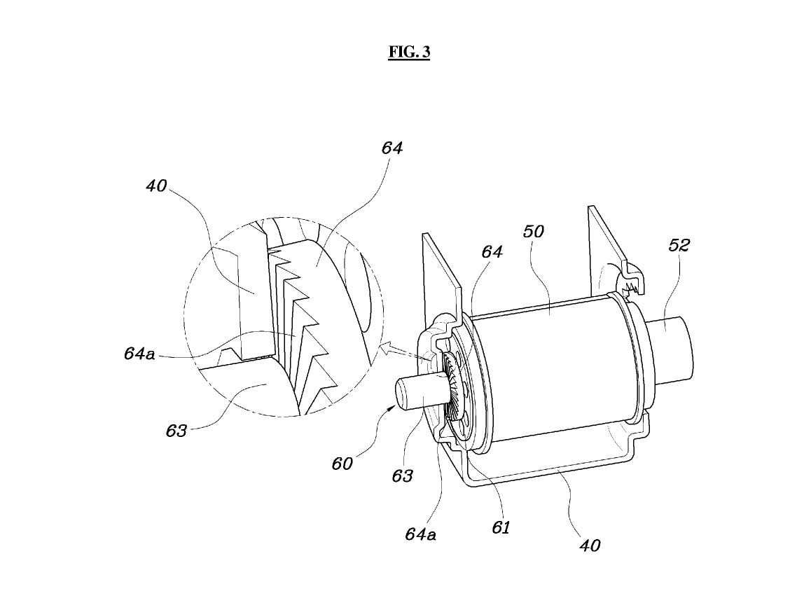

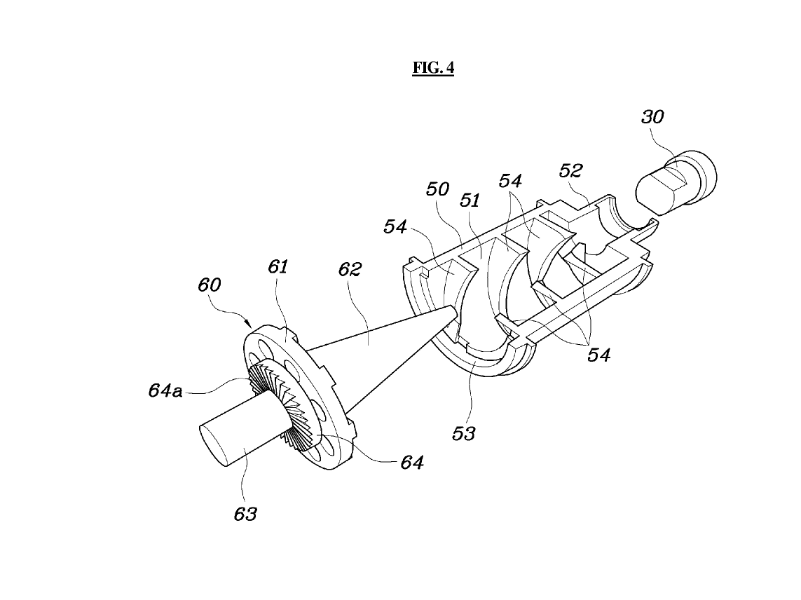

As shown in FIGS. 3 through 7, the retractor pretensioner of the vehicle seat belt according to the present invention may include a spool 50 and a valve shaft 60. The seat belt may be wound around the spool 50. Additionally, the spool 50 may be rotatably installed in a frame 40 to allow the spool 50 to be rotated relative to the frame 40 by gas pressure transmitted from a gas generator 30 to the spool 50. The valve shaft 60 may be installed in the spool 50 and operate as a rotating shaft of the gas generator 30 with respect to the frame 40 when the gas generator 30 is not operated and as a valve through which gas may be discharged out of the spool 40, when the gas generator 30 is operated.

The gas generator 30 may be installed in a first end of the spool 50 to connect the gas generator 30 to the spool 50. This installation structure of the spool 50 may reduce the overall size of the pretensioner.

The spool 50 according to the present invention may include a gas passageway 51, an installation part 52, a gas discharge aperture 53 and an impeller 54. The gas passageway 51 may be disposed within the spool 50. The installation part 52 may be connected to the gas passageway 51 and may be disposed on the first end of the spool 50. The gas generator 30 may be installed in the installation part 52. The gas discharge aperture 53 may be formed in a second end of the spool 50 to allow the gas passageway 51 to communicate with the exterior through the gas discharge aperture 53. The impeller 54 may be disposed in the gas passageway 51. The impeller 54 may be configured to guide the gas generated from the gas generator 30, towards the gas discharge aperture 53 and rotate the spool 50 with force generated by the gas flow.

Furthermore, when the gas generator 30 is not operated, the valve shaft 60 may be configured to seal the gas discharge aperture 53 of the spool 50 and, when the gas generator 30 is operated, the valve shaft 60 may be moved away from the spool 50 by the gas pressure to open the gas discharge hole 53.

In particular, the valve shaft 60 may include a valve plate 61, an internal shaft 62 and a rotating shaft 63. The valve plate 61 may be configured to open and close the gas discharge aperture 53. The internal shaft 62 may protrude from a first surface of the valve plate 61 and may be disposed through the impeller 54. The rotating shaft 63 may protrude from a second surface of the valve plate 61. A front end of the rotating shaft 63 may be rotatably disposed in a shaft aperture 41 which may be formed in the frame 40.

The valve shaft 60 according to the present invention may further include a disc 64 that protrudes from the second surface of the valve plate 61. Stopper protrusions 64a that may form a serrated cross-section may be disposed on a front surface of the disc 64 to be successively connected to each other with respect to a circumferential direction of the disc 64.

When the valve plate 61 is moved towards the frame 40 by the gas pressure, the stopper protrusions 64a may come into contact with (e.g., abut) the frame 40, thus preventing the valve shaft 60 from rotating. The internal shaft 62 may be a conical shape in which the cross-sectional area thereof is gradually reduced from the end thereof that is connected to the valve plate 61 to the other end adjacent to the gas generator 30. The conical shape allows the internal shaft 62 to be substantially smoothly removed from the impeller 54 by the gas pressure.

Moreover, when the gas generator 30 is not operated, no space may form between the internal shaft 62 and the impeller 54. In other words, when the gas generator 30 is not operated, space is may not be formed between the internal shaft 62 and the impeller 54 to maintain a seal therebetween. Therefore, when the gas generator 30 is operated, the gas pressure applied to the impeller 54 at an initial stage of generation of gas may increase, thus increasing the rotating force of the impeller 54.

The operation of the present invention will be described below.

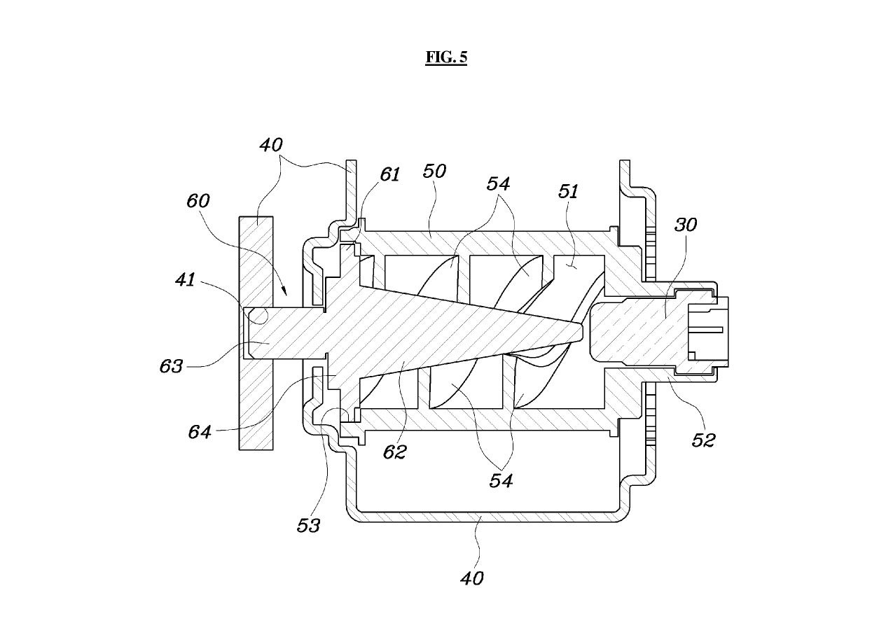

FIG. 5 illustrates the state of the retractor pretensioner when the gas generator 30 is not operated. In particular, the spool 50 may be substantially smoothly rotated by the rotating shaft 63 with respect to the frame 40. Thus, the spool 50 may operate as a retractor which, using elastic force of a spring, may be configured to retract the seat belt that has been unwound.

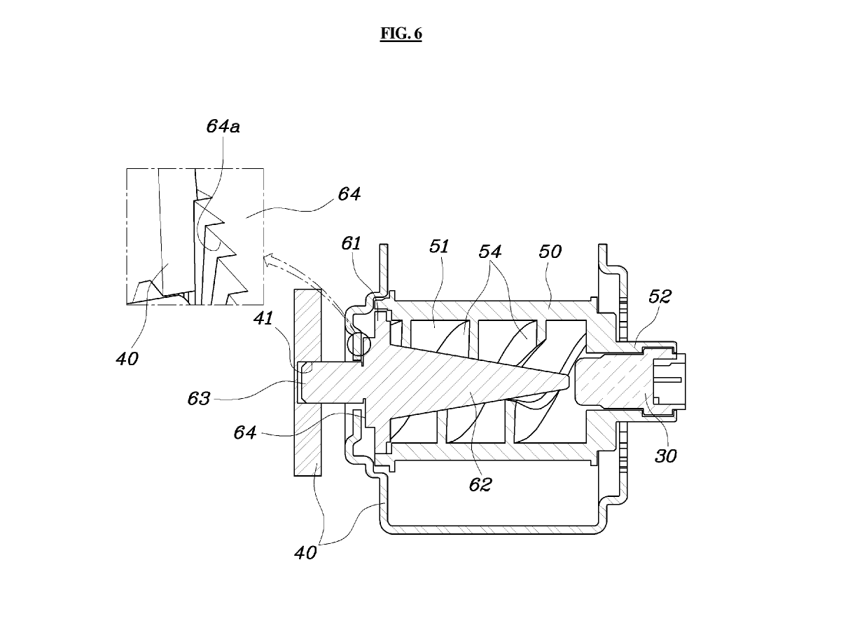

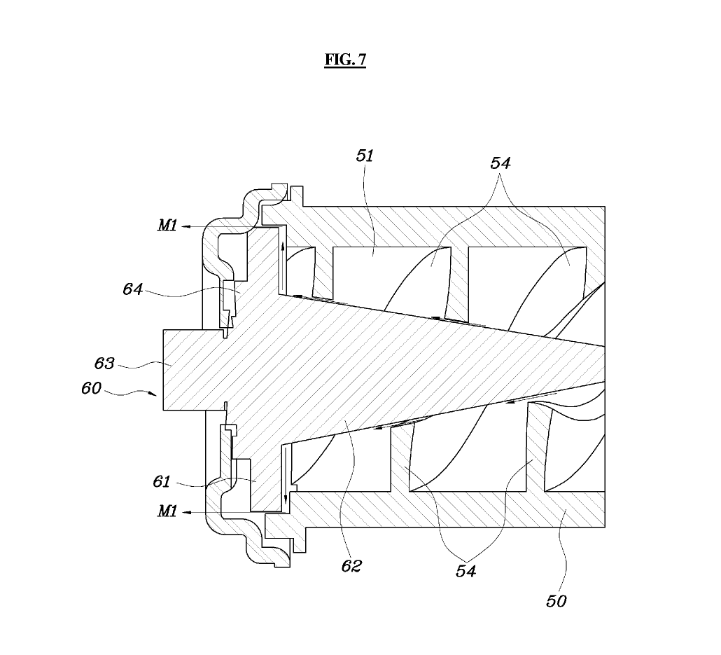

FIGS. 6 and 7 illustrate the state of the retractor pretensioner during a vehicle accident and the gas generator 30 is operated. When a vehicle accident occurs, the gas generator 30 may be operated by a control signal of a controller to generate gas. The gas may apply pressure to the impeller 54, thus rotating the spool 50. Simultaneously, the gas may flow towards the gas discharge aperture 53 under the guidance of the impeller 54.

Additionally, gas that has moved to the gas discharge aperture 53 may apply pressure to the valve plate 61 to allow the valve plate 61 to move towards the frame 40 which may be disposed on an exterior of the spool 50. In particular, while the valve shaft 60 moves towards the frame 40, the valve shaft 60 may be rotated around an axis thereof by the gas flow that moves along the impeller 54. When the valve plate 61 comes into contact with the frame 40 (e.g., abuts the frame), the stopper protrusions 64a may be locked to the frame 40 to prevent the valve shaft 60 from rotating.

Furthermore, when the valve plate 61 is moved toward the frame 40 to an exterior of the spool 50 by the gas pressure, space may be formed between the impeller 54 and the internal shaft 62, and the gas discharge aperture 53 may simultaneously open. Thus, gas may be discharged out of the spool 50 through the gas discharge aperture 53 (refer to arrow M1 of FIG. 7).

Moreover, when the accident occurs, the spool 50 may be rotated in one direction by the gas pressure, the seat belt may be wound around the spool 50, thus fixing the upper body of a passenger. In particular, the spool 50 may operate as a pretensioner.

Furthermore, the gas generated from the gas generator 30 may be discharged out of the spool 50 through the gas discharge aperture 53. Thus, the present invention may prevent an overshoot phenomenon, in which reverse rotation of the spool 50 is impeded by residual pressure of gas when a load limiter function is performed. Therefore, the present invention may prevent an initial load of the seat belt from being increased when the load limiter function is performed, thus enhancing the performance of protecting the passenger.

Furthermore, the gas generator 30 may be integrally coupled to the first end of the spool 50. The elements of the spool 50 including the gas passageway 51, the impeller 54, the valve shaft 60, etc. which may be operated by the gas pressure may be integrally disposed within the spool 50. Therefore, compared to the conventional steel ball type pretensioner or the conventional rack type pretensioner, the size of the present invention may be reduced, thus reducing the required installation space.

Moreover, unlike the conventional technique, the present invention may use, to rotate the spool 50, the impeller 54 which may be integrally formed in the spool 50, without requiring a steel ball or a rack. Therefore, the present invention may reduce the number of parts, thus reducing the manufacturing cost and the weight of the pretensioner.

Although the exemplary embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A retractor pretensioner of a vehicle seat belt, comprising:
a spool around which the seat belt is wound, wherein the spool is rotatably installed in a frame to rotate the spool relative to the frame by gas pressure transmitted from a gas generator to the spool; and
a valve shaft installed in the spool, wherein the valve shaft operates as a rotating shaft of the gas generator with respect to the frame when the gas generator is not operated and as a valve, through which the gas is discharged out of the spool, when the gas generator is operated.

2. The retractor pretensioner as set forth in claim 1, wherein the gas generator is installed in a first end of the spool to connect the gas generator to the spool.

3. The retractor pretensioner as set forth in claim 1, wherein the spool includes:
a gas passageway disposed within the spool;
an installation part connected to the gas passageway and disposed on the first end of the spool, wherein the gas generator is installed in the installation part;
a gas discharge aperture through which the gas passageway communicates with an exterior of the spool; and
an impeller disposed within the gas passageway, wherein the impeller is configured to guide the gas generated from the gas generator, towards the gas discharge aperture and rotate the spool with force generated by gas flow.

4. The retractor pretensioner as set forth in claim 3, wherein when the gas generator is not operated, the valve shaft is configured to seal the gas discharge aperture of the spool and, when the gas generator is operated, the valve shaft is moved away from the spool by the gas pressure to open the gas discharge aperture.

5. The retractor pretensioner as set forth in claim 3, wherein the valve shaft includes:
a valve plate configured to open and close the gas discharge aperture;
an internal shaft protruding from a first surface of the valve plate, wherein the internal shaft is disposed through the impeller; and
a rotating shaft protruding from a second surface of the valve plate, wherein the rotating shaft includes an end rotatably disposed in a shaft aperture formed in the frame.

6. The retractor pretensioner as set forth in claim 5, wherein the valve shaft further includes a disc protruding from the second surface of the valve plate.

7. The retractor pretensioner as set forth in claim 5, wherein a plurality of stopper protrusions having a serrated cross-section are disposed on a surface of the disc to connect the stopper protrusions to each other with respect to a circumferential direction of the disc and when the valve plate is moved toward the frame by the gas pressure, the stopper protrusions come into contact with the frame, to prevent the valve shaft from rotating.

8. The retractor pretensioner as set forth in claim 5, wherein the internal shaft has a conical shape in which a cross-sectional area thereof is gradually reduced from an end thereof that is connected to the valve plate to the other end adjacent to the gas generator.

9. The retractor pretensioner as set forth in claim 5, wherein when the gas generator is not operated, no space is formed between the internal shaft and the impeller.
